(19) United States
(12) Patent Application Publication
(10) Pub. No.: US 2021/0170803 A1
(43) Pub. Date: Jun. 10, 2021

(54) Tread Profile of a Vehicle Tyre

(71) Applicant: Continental Reifen Deutschland GmbH, Hannover (DE)

(72) Inventors: Florian Kristen, Hannover (DE); Alexander Wuest, Hannover (DE)

(73) Assignee: Continental Reifen Deutschland GmbH, Hannover (DE)

(21) Appl. No.: 16/771,825

(22) PCT Filed: Oct. 4, 2018
(86) PCT No.: PCT/EP2018/076941

§ 371 Date: Jun. 11, 2020

(30) Foreign Application Priority Data
Dec. 11, 2017 (DE) 10 2017 222 342.1

(51) Int. Cl. B60C 11/13; B60C 11/03

(52) U.S. Cl. CPC B60C 11/1392; B60C 11/0304; B60C 2011/0355; B60C 2011/0369; B60C 2011/0362; B60C 2011/0351

(57) ABSTRACT

A tread profile of a vehicle tyre having profile elements (1, 2, 3, 4, 5, 6) which are separated from one another by channels (7, 8, 9, 10, 11) and are delimited radially outwardly by a radially outer surface (12), and with additional shallow grooves (13) which are formed in the radially outer surface (12) of profile elements (1, 2, 3, 4, 5, 6) and are delimited inwardly in the radial direction R by a groove base (14), and are formed with decreasing depth T along the extent of the groove (13), starting from a position of the greatest depth T_{MAX} of the groove (13) to the extent end of the groove (13) pointing away from the deepest point, characterized in that the groove base (14) is formed with a constantly rising depth profile along the extent of the groove (13), starting from a position of the greatest depth T_{MAX} of the groove (13) to the extent end of the groove (13) pointing away from the deepest point and formed in the radially outer surface (12), and in that, at least in a first extent portion which extends as far as the extent end in the radially outer surface (12), the depth profile of the groove base (14) is formed such that it rises in a degressive curve and with a tangential transition to the radially outer surface (12).

The invention concerns a tread profile of a vehicle tyre—in particular a utility vehicle tyre—having profile elements which are separated from one another by channels and are delimited radially outwardly by a radially outer surface, and with additional shallow grooves which are formed in the radially outer surface of profile elements and are delimited inwardly in the radial direction by a groove base, and are formed with decreasing depth along the extent of the groove, starting from a position of the greatest depth of the groove to the extent end of the groove pointing away from the deepest point.

Vehicle tyres of this type are known. In order to improve grip in off-road usage, it is known to form additional shallow grooves in the radially outer surface of profile elements, which are delimited by channels, of pneumatic tyres of utility vehicles. In off-road use in particular, material from the ground can then penetrate into the groove. Groove flanks allow additional grip of the tyre and hence improve traction or braking effect in off-road usage. The shallow form of the grooves allows safe implementation of the high desired stiffness of the profile element during use of the utility vehicle without additional measures. The usual designs of such pneumatic tyres of utility vehicles, with shallow grooves in raised profile elements, are however configured with relatively sharp-edged transitions between the grooves flanks and the groove base, which may promote the formation of cracks in the groove base. In particular in off-road usage of utility vehicle tyres, this may contribute to an undesirably heavy wear and undesirable premature failure of the tyre, and hence reduce the durability.

JP 2012035664 A discloses a car tyre with such shallow grooves in the radially outer surface of profile block elements that are delimited by channels, wherein the groove base rises constantly, starting from the deepest point of the groove along its extent up to the extent end pointing away from the position of the deepest point. The extent end of the groove base here ends at a pronounced radial distance from the radially outer surface of the profile block element. Thus the extent end forms a stepped transition to the radially outer surface. Because of the rising profile of the groove base, this design indeed allows an improved stress distribution and high stiffness of the profile block element despite the provision of grip edges. However, with this design, the transition formed between the groove base and the radially outer surface in the extension direction of the circumferential channel is not constant and has sharp edges at the groove base, which may promote the formation of cracks in the groove base. Such a design would still be associated with restricted durability in the channel base in off-road usage of utility vehicle tyres.

The invention is based on the object of allowing the design of such vehicle tyres utilizing the advantages of shallow grooves, in particular for off-road usage of utility vehicle tyres, while reducing the potential for crack formation.

According to the invention, the object is achieved by the design of a tread profile of a vehicle tyre—in particular a utility vehicle tyre—having profile elements which are separated from one another by channels and are delimited radially outwardly by a radially outer surface, and with additional shallow grooves which are formed in the radially outer surface of profile elements and are delimited inwardly in the radial direction by a groove base, and are formed with decreasing depth along the extent of the groove, starting from a position of the greatest depth of the groove to the extent end of the groove pointing away from the deepest point, according to the features of claim 1; wherein the groove base is formed with a constantly rising depth profile along the extent of the groove, starting from a position of the greatest depth of the groove to the extent end of the groove pointing away from the deepest point and formed in the radially outer surface, and wherein, at least in a first extent portion which extends as far as the extent end in the radially outer surface, the depth profile of the groove base is formed such that it rises in a degressive curve and with a tangential transition to the radially outer surface.

This design allows the vehicle tyre to still be produced with profile elements delimited by channels, utilizing the advantageous design of a shallow groove in the radially outer surface of the profile element in order to achieve good grip properties with high stiffness. The depth profile of the groove along its extent, starting from the deepest point up to the extent end of the groove pointing away from the deepest point, with its constantly rising design and degressively rising depth profile up to the extent end, with tangential transition to the radially outer surface, allows a particularly favourable stress distribution in the extension direction of the groove without sharp-edged transitions to the surface. The depth profile, which rises with a degressive curve with tangential transition, allows optimal transfer of forces to the groove base with minimum stress. Thus in off-road usage, the risk of crack formation in the groove base may be further reduced and the durability improved.

The implementation and use of utility vehicle tyres, as desired for vehicles in the building site, construction, mining or quarrying sectors or in other off-road uses, may thus be further improved.

The design of a vehicle tyre according to the features of claim 2 is particularly advantageous, wherein in a second extent portion—in particular starting from a position of greatest depth of the groove and extending up to the first extent end —, the groove base is formed with a depth profile which rises substantially linearly along the extent of the groove, starting from a position of the greatest depth of the groove to the extent end of the groove pointing away from the deepest point. This may even out the abrasion of the groove, and the effect of the grip edges can be maintained for a long time.

The design of a vehicle tyre according to the features of claim 3 is particularly advantageous, wherein the depth profile of the groove is formed with a depth profile which rises in a curve along its entire extent, starting from a position of the greatest depth to the extent end of the groove pointing away from the deepest point and formed in the radially outer surface. This may further improve the stress distribution in the groove base.

The design of a vehicle tyre according to the features of claim 4 is particularly advantageous, wherein the depth profile of the groove is formed with a depth profile which rises in a degressive curve along its entire extent, starting from a position of the greatest depth to the extent end of the groove pointing away from the deepest point and formed in the radially outer surface. In this way, it is possible both to even out abrasion of the groove and maintain the effect of the grip edges for a long time, and also further improve the stress distribution in the groove base.

The design of a vehicle tyre according to the features of claim 5 is particularly advantageous, wherein the depth profile of the groove is formed so as to rise in a curve with a turning point of the direction of curvature, along its extent, starting from the position of the greatest depth to the extent end of the groove pointing away from the deepest point and formed in the radially outer surface, wherein in particular, the groove base, in a second extent portion extending up to the first extent end, is formed with a depth profile which rises in a progressive curve along the extent of the groove, starting from a position of the greatest depth of the groove, and the turning point of the curvature direction of the depth profile is formed in the transition between the second and first extent portions. In this way, the stress in the groove base may be minimized and effective grip edges can be maintained for a long time despite abrasion.

The design of a vehicle tyre according to the features of claim 6 is particularly advantageous, wherein along its extent, the groove is delimited on both sides of the groove base by a respective groove flank, which each extend from the radially outer surface inwardly in the radial direction R, so as to enclose a tilt angle, measured in the section planes perpendicular to the extension direction of the groove, to the radial direction R, as far as the groove base, wherein along the extent of the groove, in the section planes perpendicular to the extension direction of the groove, the one flank is formed with a tilt angle α of which the minimum αₘᵢₙ formed in the groove is 20°≤αₘᵢₙ≤60°, and the other flank is formed with a tilt angle β, of which the minimum βₘᵢₙ formed in the groove is 20°≤βₘᵢₙ≤60°.

The design of a vehicle tyre according to the features of claim 7 is particularly advantageous, wherein along the extent of the groove, starting from the position of the deepest point in which α is αₘᵢₙ and β is βₘᵢₙ, up to the extent end of the groove pointing away from the deepest point and formed in the radially outer surface, at least one—in particular both—flank(s) are formed with a flank angle which increases, in particular continuously, wherein the flank angle(s) has/have their maximum value of 90° in the extent end. This allows a completely edge-free transition into the radially outer surface at the extent end of the groove.

The design of a vehicle tyre according to the features of claim 8 is particularly advantageous, wherein along the extent of the groove, starting from the deepest point of the groove up to the extent end of the groove pointing away from the deepest point and formed in the radially outer surface, the two flanks intersect at their radially inner extent end and thus form a linear groove base in the section line.

The design of a vehicle tyre according to the features of claim 9 is particularly advantageous, wherein along the extent of the groove, starting from the deepest point of the groove up to the extent end of the groove pointing away from the deepest point and formed in the radially outer surface, the two flanks intersect, in the section planes formed perpendicularly to the extension direction, at a distance from each other which forms the width of the groove base, wherein the distance and hence the width of the groove base is formed decreasing along the extent of the groove, starting from the deepest point of the groove in the direction of the extent end of the groove pointing away from the deepest point and formed in the radially outer surface.

The design of a vehicle tyre according to the features of claim 10 is particularly advantageous, wherein several—in particular two—such grooves formed in the profile element open into each other at the position of their deepest point so as to enclose an angle δ of their extension direction.

The design of a vehicle tyre according to the features of claim 11 is particularly advantageous, wherein two such grooves formed in the profile element open into each other at the position of their deepest point so as to enclose an angle δ of their extension direction, with 45° 5135°. In this way, circumferential and transverse forces may be absorbed.

The design of a vehicle tyre according to the features of claim 12 is particularly advantageous, wherein the position of the deepest point of the groove is positioned in a channel wall delimiting the profile element. In this way, water may be discharged optimally from the groove into the channel.

The design of a vehicle tyre according to the features of claim 13 is particularly advantageous, wherein the position of the deepest point of the groove is positioned at a distance from the channels delimiting the profile element. This may optimally counter an uneven abrasion.

The design of a vehicle tyre according to the features of claim 14 is particularly advantageous, wherein the tread profile is configured as an off-road profile.

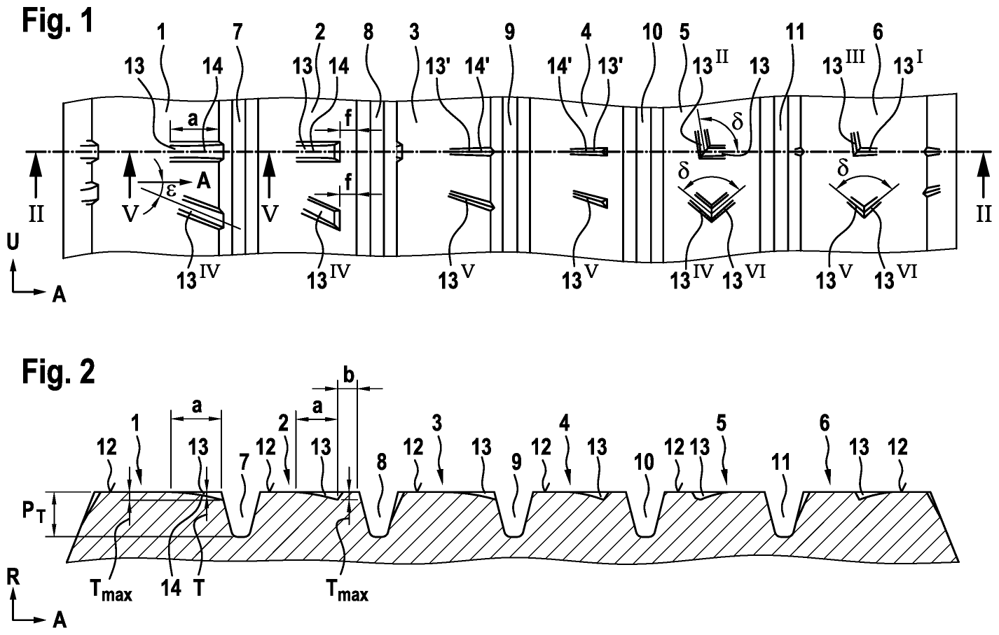

The invention will be discussed in more detail below on the basis of the exemplary embodiments illustrated in FIGS. 1 to 8. The drawings show:

FIG. 1 a circumferential portion of a pneumatic utility vehicle tyre in plan view,

FIG. 2 a sectional depiction of the tread profile of a utility vehicle tyre along section line II-II in FIG. 1,

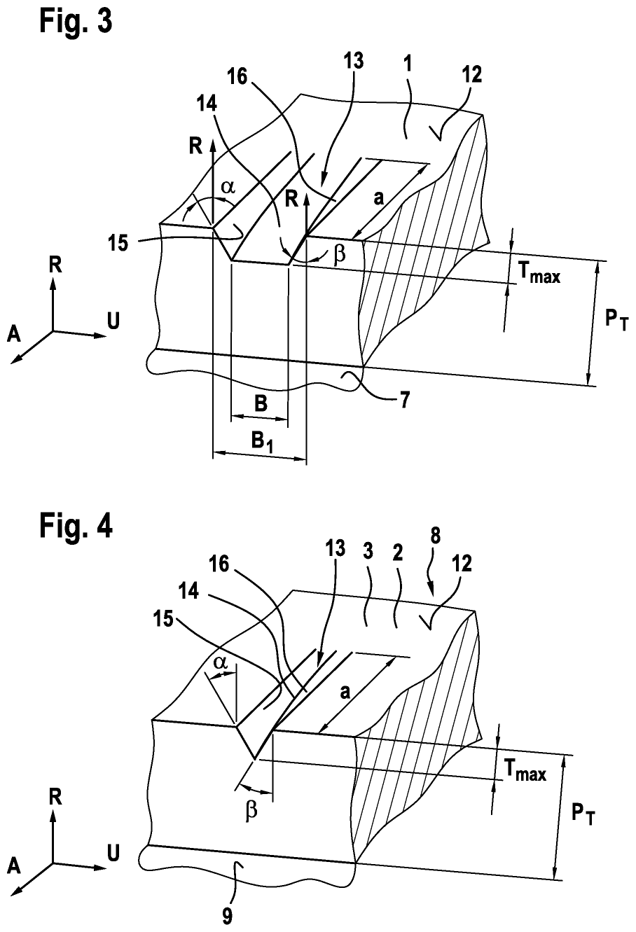

FIG. 3 an extract of a profile element portion from FIG. 1 in perspective view, to illustrate the groove formation in one embodiment,

FIG. 4 another extract of a profile element from FIG. 1 in perspective view, to illustrate the groove formation in an alternative embodiment,

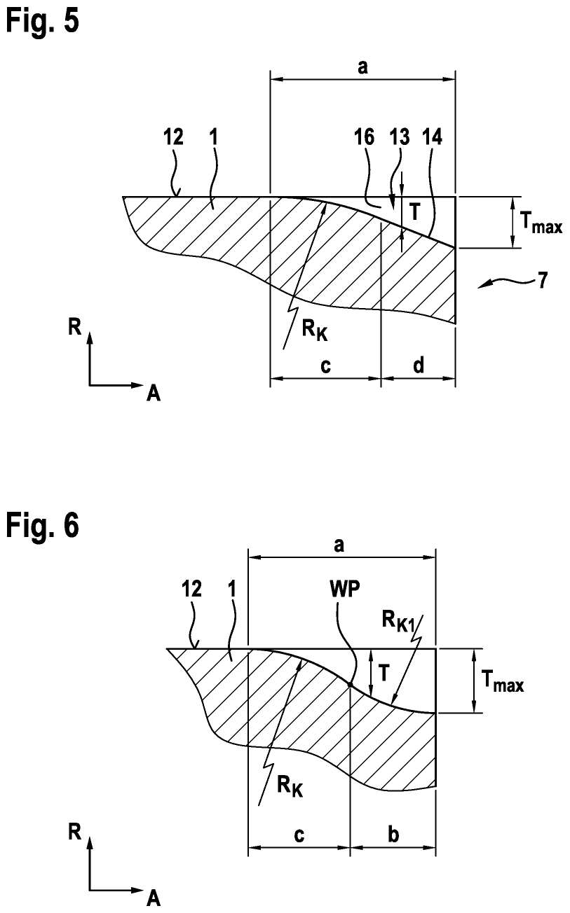

FIG. 5 a profile element from FIG. 1 in sectional view along section line V-V from FIG. 1, to illustrate the depth profile of a groove,

FIG. 6 a profile element from FIG. 1 in sectional view along section line V-V from FIG. 1, to illustrate an alternative depth profile of a groove,

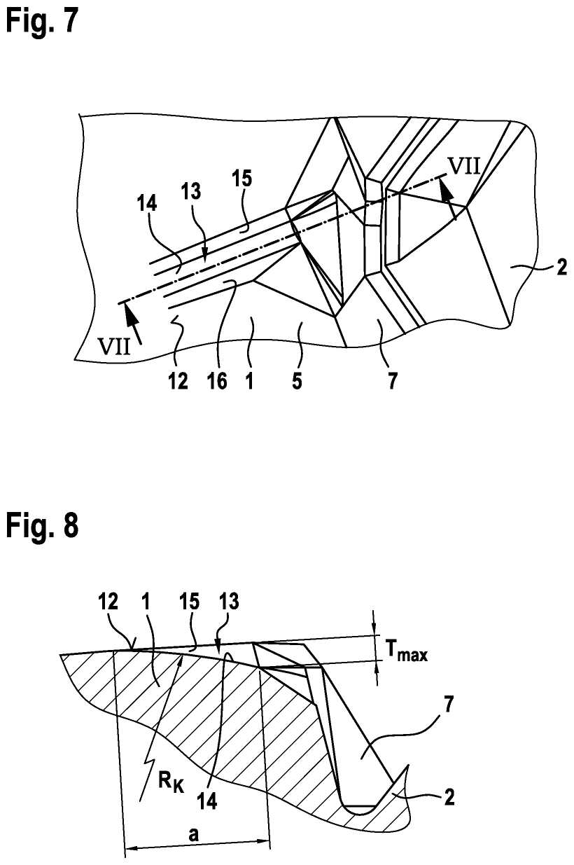

FIG. 7 the top view of a portion of a tread profile of another off-road utility vehicle tyre for use on building sites (construction tyre), and

FIG. 8 a profile element from FIG. 7 in sectional view along section line VIII-VIII from FIG. 7, to illustrate the depth profile of a groove in a further embodiment.

FIGS. 1 and 2 show a circumferential portion of a tread profile of a pneumatic utility vehicle tyre with several circumferential ribs of known type arranged next to each other in the axial direction A of the pneumatic vehicle tyre. The circumferential ribs 1, 2, 3, 4, 5 and 6 are profile ribs which extend over the circumference of the pneumatic vehicle tyre and are oriented in the circumferential direction U of the pneumatic vehicle tyre, and are separated from each other in the axial direction A of the pneumatic vehicle tyre in the known manner by circumferential channels 7, 8, 9, 10 and 11.

The circumferential ribs 1 and 6 are each formed in a shoulder of the pneumatic vehicle tyre and form the shoulder ribs. The circumferential ribs 2, 3, 4 and 5 are formed between the two shoulder ribs 1 and 6 in the axial direction A. The circumferential rib 1 and the circumferential rib 2 are separated from one another in the axial direction A by a circumferential channel 7, which extends in the circumferential direction U and is oriented in the circumferential direction U. The circumferential rib 2 and the circumferential rib 3 are separated from one another in the axial direction A by a circumferential channel 8 of known type, which extends over the entire circumference and is oriented in the circumferential direction U. The circumferential rib 3 and the circumferential rib 4 are separated from one another in the axial direction A by a circumferential channel 9, which extends over the entire circumference of the pneumatic vehicle tyre and is oriented in the circumferential direction U. The circumferential rib 4 and the circumferential rib 5 are separated from one another in the axial direction A of the pneumatic vehicle tyre by a circumferential channel 10 which extends over the entire circumference of the pneumatic vehicle tyre and is oriented in the circumferential direction U. The circumferential rib 5 and the circumferential rib 6 are separated from one another in the axial direction A of the pneumatic vehicle tyre by a circumferential channel 11, which extends over the entire circumference of the pneumatic vehicle tyre and is oriented in the circumferential direction U.

The circumferential ribs 1, 2, 3, 4, 5 and 6 are delimited toward the outside in the radial direction R of the pneumatic vehicle tyre by a radially outer surface 12 which forms the ground contact surface.

The circumferential channels 7, 8, 9, 10 and 11 are delimited inwardly in the radial direction R in the known fashion by a channel base which extends over the circumference of the pneumatic vehicle tyre. The circumferential channels 7, 8, 9, 10 and 11 are formed with a depth P_{T}, measured in the radial direction R of the pneumatic vehicle tyre, which corresponds to the profile depth of the tyre.

As shown in FIGS. 1 and 2, additional shallow grooves 13 are formed in the radially outer surface 12 of each of the circumferential ribs 1 to 6. As an example, different embodiments of such shallow grooves are shown in the various circumferential ribs 1 to 6 in FIG. 1 and FIG. 2 for illustration.

As evident from FIG. 1 and FIG. 2, grooves 13 are formed in the circumferential rib 1, which are distributed over the circumference of the pneumatic vehicle tyre and arranged successively in the circumferential direction U; said grooves extend outwardly in the axial direction A, starting from the circumferential channel 7 delimiting the circumferential rib 1 in the axial direction A, in the extension direction of the groove 13 with an extent length a measured in the radially outer surface 12.

As shown in FIG. 1, FIG. 2 and FIG. 3, in the radial direction R, the groove 13 is inwardly delimited by a respective groove base 14. The groove base 14 is formed extending in linear fashion, starting from the channel wall of the circumferential channel 7 delimiting the circumferential rib 1 towards the circumferential channel 7, along the extent of the groove 13 in the extension direction of the groove in the radially outer surface 12, over the extent length a of the groove 13, and is oriented in the axial direction A of the pneumatic vehicle tyre. In the section planes formed along the extension direction of the groove 13, as shown in FIGS. 2, 3 and 5, the groove 13 is formed with a channel base 14 which rises constantly in the radial direction R, starting from the channel wall of the circumferential channel 7 delimiting the circumferential rib 1, along the extent of the groove 13 over the extent length a, and hence with a constantly reducing profile of the depth T of the groove 13 measured in the radial direction R. The groove 13 is formed with a maximum depth Tₘₐₓ in the position of the channel wall. Starting from this position, the groove 13 is formed with diminishing depth profile along its extent over the entire extent length a.

FIG. 2 shows the groove 13 of the circumferential rib 1 in an embodiment in which the groove 13 is formed with a curved depth profile which decreases degressively along its entire extent in the circumferential rib 1, starting from the position in the channel wall in which the groove depth has its maximum value Tₘₐₓ up to its extent end. In this exemplary embodiment, in the section planes formed along the extension direction of the groove, the groove base 14 is formed curved along its entire extent about a curve centre point (not shown) that is positioned in a radial position below the groove base 14. At the extent end of the groove 13, at a distance a from the circumferential channel 7, the groove base 14 transforms tangentially into the radially outer surface 12 of the circumferential rib 1.

FIG. 5 shows an alternative embodiment of the depth profile of the groove base 14 of the groove 13, in which starting from its position of maximum depth Tₘₐₓ formed in the channel wall of the circumferential channel 7, the groove base 14 rises in linear fashion and hence constantly in a first extent portion of the extent line d measured in the extension direction of the groove 13 in the radially outer surface 12; and in an adjacent second extent portion of the extent length c which extends up to the extent end pointing away from the deepest point of the groove 13 at a distance a, with a=(c+d), from the position of the deepest point and hence away from the circumferential channel 7, as in the form depicted in FIG. 2 and described above, said groove base is formed curved about a curve centre point (not shown) that is positioned in a radial position below the groove base 14; and at this extent end pointing away from the deepest point of the groove 13, at the distance a from the position of the deepest point, said groove base transforms tangentially into the radially outer surface 12. In this exemplary embodiment, the groove 13 is thus formed along its extent, starting from the position of its greatest depth, with a depth profile which decreases constantly in the first extent portion and decreases with a degressive curve in the adjacent second extent portion up to the extent end.

The extent length a is configured such that 5 mm≤a≤50 mm.

In the exemplary embodiment in FIG. 5, the extent length d is such that 2.5 mm≤d≤47.5 mm and c is such that 2.5 mm≤c≤47.5 mm.

For normal requirements, the extent length a is selected such that

10 mm≤a≤35 mm.
For example, a=18 mm, c=9 mm and d=9 mm.

FIG. 6 shows a further alternative embodiment of the depth profile of the groove 13, in which the groove base 14, starting from the position of the deepest point Tₘₐₓ, in the extension direction of the groove 13, over a first extent portion of extent length b, is curved about a curve centre point that is formed radially outside the groove base 14, and hence the groove is formed with a progressively decreasing depth profile. The depth profile is formed with a turning point WP at the extent end of this first extent portion of extent length b. From this position, a second extent portion of extent length c follows, which extends up to the extent end of the groove 13 at a distance a from the position of the deepest point. In this second extent portion, the groove base 14—as described in the exemplary embodiment of FIG. 5 described above—is curved about a curve centre point (not shown) that is positioned in a radial position below the groove base 14, and hence the groove 13 is formed with a curved depth profile that decreases degressively. At this extent end of the groove 13 pointing away from the deepest point of the groove 13, at a distance a from the position of the deepest point, the groove base 14 transforms tangentially into the radially outer surface 12. Here a=(b+c).

The extent length a is configured such that 10 mm≤a≤35 mm. In the exemplary embodiment in FIG. 6, the extent length b is such that 2.5 mm≤b≤47.5 mm and c is such that 2.5 mm≤c≤47.5 mm.

As depicted in FIG. 3, the groove base 14 of the groove 13 is formed with an extent width B measured transversely to the extension direction of the groove 13. On both sides of the groove base 14, the groove is delimited by respective groove flanks 15 and 16 which are tilted in the section planes formed perpendicularly to the extension direction of the groove, enclosing a respective tilt angle α and β to the radial direction R. Here, the flank 15 is tilted enclosing the tilt angle α and the flank 16 is tilted enclosing the tilt angle β. The tilt direction of the flanks 15 and 16 is configured such that the flanks 15 and 16 are tilted in the direction pointing away from the groove 13 along the radial extent of the groove 13, starting from the groove base 14 in the direction towards the radially outer surface 12. The tilt angles α and μ of the groove 13 are here formed with their minimum values αₘᵢₙ and βₘᵢₙ in the position of the deepest point with depth Tₘₐₓ, and increase constantly along the extent of the groove 13 over the entire extent portion of the extent length a up to the extent end pointing away from the deepest point, and reach their maximum with α=90° and β=90° at the extent end. The flank 15 and the flank 16 thus lie in the radially outer surface 12 at the extent end and form a flowing transition to the radially outer surface 12.

The minimum value αₘᵢₙ or βₘᵢₙ in the position of the deepest point of the groove 13 is here formed with 20°≤αₘᵢₙ≤60° or 20°≤βₘᵢₙ≤60°. For example, αₘᵢₙ=40° and βₘᵢₙ=40°.

Thus in a symmetrical design, α=β.

In another, asymmetrical design, αₘᵢₙ>βₘᵢₙ.

The maximum depth Tₘₐₓ is (0.05 P_{T})≤Tₘₐₓ≤(0.25 P_{T}). In the typical configuration of conventional off-road utility vehicle tyres, (0.1 P_{T})≤Tₘₐₓ≤(0.2 P_{T}).

The profile depth P_{T} of such pneumatic utility vehicle tyres is usually

20 mm≤P_{T}≤25 mm.

In an exemplary embodiment, starting from the position of the deepest point Tₘₐₓ up to its extent end, the groove base 14 is formed with constant width B along the extent of the groove base.

In an alternative embodiment, starting from the position of the deepest point of the groove 13 in which the groove base has its maximum width B, the groove base 14 is formed with continuously decreasing width B along the extent of the groove base up to its extent end.

FIG. 4 shows an exemplary embodiment of a groove 13 in which the groove base 14 is formed with a width B=0 along its entire extent, starting from the position of the deepest point of the groove 13 up to the extent end of the groove 13, so that the flanks 15 and 16 intersect in a linear groove base 14. Otherwise, the groove 13 is configured according to the various alternative embodiments, as in the different embodiments described above.

Such an embodiment of a groove 13 is depicted in FIG. 1 using the example of the circumferential rib 3, as a groove 13′ with groove base 14′.

FIG. 1 shows a further alternative embodiment of the groove 13 in the form of the groove 13^{IV} in the circumferential rib 1. In this embodiment, the groove 13^{IV}, with its extension direction in the radially outer surface 12, is formed tilted to the axial direction A of the pneumatic vehicle tyre enclosing an angle ε, with 45°≥ε>0°.

Similarly, in FIG. 1, the exemplary embodiment shown of a groove 13^{V} in the circumferential rib 3 is an alternative design to the exemplary embodiment 13′ shown, and is tilted with angle ε of its orientation to the axial direction A of the pneumatic vehicle tyre.

In the embodiments described above, the position of the deepest point of the groove 13 with depth Tₘₐₓ is in each case formed in a channel wall of a circumferential channel 7 or 9 delimiting the profile rib, so that the groove 13 or 13^{IV} or 13′ or 13^{V} opens with its deepest point into the adjacent circumferential channel 7 or 9.

In FIG. 1, an alternative design of the grooves 13 or 13^{IV}, or 13′ or 13^{V}, is shown in the circumferential ribs 2 or 4. In these embodiments, the position of the deepest point of the respective groove 13 or 13^{IV}, or 13′ or 13^{V}, is arranged at a distance from the nearest circumferential channel 8 or circumferential channel 10, and forms an extent end of the groove base 14 and a blunt end of the groove.

In the circumferential rib 5, an exemplary embodiment is shown in which a groove 13 and groove 13″ are arranged such that they have a common deepest point. The one groove 13 extends in the axial direction A, starting from this position of the deepest point, in the direction of the circumferential channel 11. The other groove 13″ extends in a different extension direction, starting from this position of the deepest point, enclosing an angle δ to the extension direction of the groove 13 in the radially outer surface 12. The angle δ is configured such that 45°≤δ≤135°. The angle δ is configured for example such that δ=95°.

As shown in FIG. 1 in the circumferential rib 5, in the embodiment shown the groove 13″ extends with a direction component oriented substantially in the circumferential direction U, and the groove 13 is oriented in the axial direction A.

In FIG. 1, the circumferential rib 5 also illustrates a further exemplary embodiment of grooves 13^{IV} and 13^{VI} with common deepest point, in which the two grooves 13^{IV} and 13^{VI} are however oriented with an extension direction having both a significant axial direction component and a significant circumferential direction component. For example, the two grooves are oriented so as to enclose an angle of 45° to the axial direction A.

The exemplary embodiment of the circumferential rib 6 in FIG. 1, similarly to the exemplary embodiments shown in FIG. 5, has two grooves 13′ and 13^{III} or 13^{V} and 13^{VI} which—like the grooves 13′ of FIG. 4—are each formed with a width B of the groove base with B=0.

In FIGS. 1 and 2, the various embodiments depicted and described of the grooves formed in the profile elements are illustrated on the basis of a utility vehicle tyre with circumferential ribs and linearly extending circumferential channels.

FIGS. 7 and 8 show a circumferential portion of another tread profile of a utility vehicle tyre (truck tyre) shown with a strongly pronounced off-road profile, with profile block elements or profile ribs delimited by a circumferential channel of a utility vehicle tyre (truck tyre). The circumferential channels of the tread profile have a plurality of kink points along their extent over the circumference of the tyre, and the channel walls of the circumferential channels have partly additional kink points with greatly differing tilt angles along the kinked course of the circumferential channels. Such tread profiles are used for example in utility vehicle off-road tyres of vehicles in the building site, construction, mining or quarrying sectors.

FIGS. 7 and 8 show an exemplary embodiment of the groove 13 in a circumferential rib, the depth profile of which is formed similarly to the illustration of the groove 13 shown in FIG. 3.

### LIST OF REFERENCE NUMERALS

### (Part of the Description)

1 Profile rib
2 Profile rib
3 Profile rib
4 Profile rib
5 Profile rib
6 Profile rib
7 Circumferential channel
8 Circumferential channel
9 Circumferential channel
10 Circumferential channel
11 Circumferential channel
Radially outer surface
13, 13^{I}, 13^{II}, 13^{III}, 13^{IV}, 13^{V},13^{VI} Groove
14, 14′ Groove base
15 Flank
16 Flank
17 Transverse channel
18 Sipe
19 Main extent portion
20 Edge extent portion
21 Sipe base
22 Channel base
23 Sipe wall
24 Sipe wall

1.-14. (canceled)

15. A tread profile of a utility vehicle comprising:
profile elements which are separated from one another by channels and are delimited radially outwardly by a radially outer surface, and with additional shallow grooves which are formed in the radially outer surface of profile elements and are delimited inwardly in the radial direction R by a groove base, and are formed with decreasing depth T along the extent of the groove, starting from a position of the greatest depth TMAX of the groove to the extent end of the groove pointing away from the deepest point,
wherein the groove base is formed with a constantly rising depth profile along the extent of the groove, starting from a position of the greatest depth TMAX of the groove to the extent end of the groove pointing away from the deepest point and formed in the radially outer surface, and
wherein, at least in a first extent portion which extends as far as the extent end in the radially outer surface, the depth profile of the groove base is formed such that it rises in a degressive curve and with a tangential transition to the radially outer surface.

16. The tread profile of claim 15, wherein in a second extent portion starting from a position of greatest depth TMAX of the groove and extending up to the first extent end, the groove base is formed with a depth profile which rises substantially linearly along the extent of the groove, starting from a position of the greatest depth TMAX of the groove to the extent end of the groove pointing away from the deepest point.

17. The tread profile of claim 15, wherein the depth profile of the groove is formed with a depth profile which rises in a curve along its entire extent, starting from a position of the greatest depth TMAX to the extent end of the groove pointing away from the deepest point and formed in the radially outer surface.

18. The tread profile of claim 17, wherein the depth profile of the groove is formed with a depth profile which rises in a degressive curve along its entire extent, starting from a position of the greatest depth TMAX to the extent end of the groove pointing away from the deepest point and formed in the radially outer surface.

19. The tread profile of claim 17, wherein the depth profile of the groove is formed to rise in a curve, with a turning point WP of the direction of curvature, along its extent starting from the position of the greatest depth TMAX to the extent end of the groove pointing away from the deepest point and formed in the radially outer surface, and
wherein in a second extent portion extending up to the first extent end, the groove base is formed with a depth profile which rises in a progressive curve along the extent of the groove, starting from a position of the greatest depth TMAX of the groove, and the turning point of the curvature direction of the depth profile is formed in the transition between the second and first extent portions.

20. The tread profile of claim 15, wherein along its extent, the groove is delimited on both sides of the groove base by a respective groove flank, which each extend from the radially outer surface inwardly in the radial direction R, so as to enclose a tilt angle, measured in the section planes perpendicular to the extension direction of the groove, to the radial direction R, as far as the groove base, wherein along the extent of the groove, in the section planes perpendicular to the extension direction of the groove, the one flank is formed with a tilt angle α of which the minimum α min formed in the groove is 20°≤α min≤60°, and the other flank is formed with a tilt angle β, of which the minimum β min formed in the groove is 20°≤β min≤60°.

21. The tread profile of claim 17, wherein along the extent of the groove, starting from the position of the deepest point TMAX in which α is α min and β is β min, up to the extent end of the groove pointing away from the deepest point and formed in the radially outer surface, in both are formed with a flank angle which increases continuously, and
wherein the flank angle(s) has/have their maximum value of 90° in the extent end.

22. The tread profile of claim 15, wherein along the extent of the groove, starting from the deepest point of the groove up to the extent end of the groove pointing away from the deepest point and formed in the radially outer surface, the two flanks intersect at their radially inner extent end and thus form a linear groove base in the section line.

23. The tread profile of claim 21, wherein along the extent of the groove, starting from the deepest point of the groove up to the extent end of the groove pointing away from the deepest point and formed in the radially outer surface, the two flanks intersect in the section planes formed perpendicularly to the extension direction, at a distance from each other which forms the width (B) of the groove base, wherein the distance and hence the width B of the groove base is formed decreasing along the extent of the groove, starting from the deepest point of the groove in the direction of the extent end of the groove pointing away from the deepest point and formed in the radially outer surface.

24. The tread profile of claim 15, wherein two grooves formed in the profile element open into each other at the position of their deepest point so as to enclose an angle δ of their extension direction.

25. The tread profile of claim 24, wherein the two grooves formed in the profile element open into each other at the position of their deepest point so as to enclose an angle δ of their extension direction, with 45°≤δ≤135°.

26. The tread profile of claim 15, wherein the position of the deepest point of the groove is positioned in a channel wall delimiting the profile element.

27. The tread profile of claim 15, wherein the position of the deepest point of the groove is positioned at a distance from the channels delimiting the profile element.

28. The tread profile of claim 15, wherein the tread profile is configured as an off-road profile.

29. A tread profile comprising:
profile elements separated from one another by channels and delimited radially outwardly by a radially outer surface, and with additional shallow grooves which are formed in the radially outer surface of profile elements and are delimited inwardly in the radial direction R by a groove base, and are formed with decreasing depth T along the extent of the groove, starting from a position of the greatest depth TMAX of the groove to the extent end of the groove pointing away from the deepest point,
wherein the groove base is formed with a constantly rising depth profile along the extent of the groove, starting from a position of the greatest depth TMAX of the groove to the extent end of the groove pointing away from the deepest point and formed in the radially outer surface,
wherein a first extent portion extends as far as the extent end in the radially outer surface, the depth profile of the groove base is formed such that it rises in a degressive curve and with a tangential transition to the radially outer surface; and
wherein two grooves formed in the profile element open into each other at the position of their deepest point so as to enclose an angle δ of their extension direction.

30. The tread profile of claim 29, wherein the two grooves formed in the profile element open into each other at the position of their deepest point so as to enclose an angle δ of their extension direction, with 45°≤δ≤135°.

31. The tread profile of claim 29, wherein the position of the deepest point of the groove is positioned in a channel wall delimiting the profile element.

32. The tread profile of claim 29, wherein the position of the deepest point of the groove is positioned at a distance from the channels delimiting the profile element.
